(19) United States
(12) Patent Application Publication
(10) Pub. No.: US 2005/0069317 A1
(43) Pub. Date: Mar. 31, 2005

(54) Ethernet passive optical network accommodating real-time broadcast/image signals and being capable of providing security for broadcast/image signals

(76) Inventors: Ki-Cheol Lee, Suwon-si (KR); Kee-Sung Nam, Seoul (KR); Yun-Je Oh, Yongin-si (KR); Tae-Sung Park, Yongin-si (KR)

Correspondence Address: CHA & REITER, LLC, 210 ROUTE 4 EAST STE 103, PARAMUS, NJ, 07652, US

(21) Appl. No.: 10/810,249

(22) Filed: Mar. 26, 2004

(30) Foreign Application Priority Data
Sep. 26, 2003 (KR) 2003-67086

(51) Int. Cl. H04J 14/00

(52) U.S. Cl. 398/67

(57) ABSTRACT

An Ethernet-PON that accommodates real-time broadcast/image signals and provides security for broadcast/image signals, allows user authentication without a CAS. An OLT in the Ethernet-PON switches digital broadcast/image data signals from a broadcaster according to respective broadcast/image selection information of users, and scrambles the switched broadcast/image data on a user-by-user basis. The scrambled data is multiplexed and converted to a broadcast/image optical signal, which is transmitted, combined with a communication signal from an IP network, to ONTs through an optical splitter. The ONTs select broadcast/image data from the broadcast/image signals according to the respective broadcast/image selection information.

### CLAIM OF PRIORITY

This application claims priority to an application entitled “ETHERNET PASSIVE OPTICAL NETWORK ACCOMMODATING REAL-TIME BROADCAST/IMAGE SIGNALS AND BEING CAPABLE OF PROVIDING SECURITY FOR BROADCAST/IMAGE SIGNALS,” filed in the Korean Intellectual Property Office on Sep. 26, 2003 and assigned Ser. No. 2003-67086, the contents of which are hereby incorporated herein by reference.

### BACKGROUND OF THE INVENTION

1. Field of the Invention

The present invention relates to a passive optical network (PON), and more particularly to an Ethernet passive optical network (Ethernet-PON) for providing high-volume, high-speed data services and real-time broadcast/image services to subscribers.

2. Description of the Related Art

Data transfer rates above 100 megabits per second (Mb/s) will be required to efficiently provide high-volume, high-speed data services and real-time digital broadcast/image services to subscribers. However, current network systems such as a cable modem or digital subscriber line (DSL) are limited to transfer rates not exceeding 50 Mb/s. This has prompted research into a high-speed transmission network capable of handling the kind of high-volume, high-speed data services and real-time digital broadcast/image services that are anticipated. An optical network has been proposed as such a high-speed transmission network, and, particularly, a passive optical network (PON) is attracting attention as a solution to economically implement the optical network.

There are various PONs such as a PON based on asynchronous transfer mode or ATM (ATM-PON), a PON based on wavelength division multiplexing or WDM (WDM-PON) and a PON based on Ethernet (Ethernet-PON or EPON). An EPON-based FTTH (Fiber to the Home) system has been proposed and developed as a system capable of enabling high-speed optical transmission to general residences.

In general, the Ethernet-PON has been developed basically in order to accommodate communication data signals. Data transmission in the Ethernet-PON is performed in such a manner that Gigabit Ethernet signals are transmitted downstream at 1.25 Gb/s from an optical line terminal (OLT) to optical network terminals (ONTs) at a wavelength of 1550 nm, whereas Gigabit Ethernet signals are transmitted upstream at 1.25 Gb/s from the ONTs to the OLT at a wavelength of 1310 nm. The use of different optical wavelengths for upstream and downstream avoids their mutual interference.

The need to allow the Ethernet-PON to accommodate broadcast signals has been suggested to meet the rising demand from broadcast services in optical networks. An overlay broadcast accommodation system has been proposed in which broadcast signals are transmitted to the ONTs through a different wavelength for broadcast signals from the wavelength for communication data, as shown in FIG. 1. In the overlay broadcast accommodation system, all broadcast channels are equally transmitted to each subscriber, so that the system uses a CAS (Conditional Access System) as a separate system for security and authentication. The CAS is not shown in FIG. 1, but is described below as to its configuration and operation.

FIG. 1 shows the configuration of a typical Ethernet-PON for integrating broadcast and communication, which includes an OLT (Optical Line Terminal) 100, a plurality of ONTs (Optical Network Terminals) 200-1 to 200-N, and a passive optical splitter 118. Further included are optical cables for connecting the OLT with the ONTs.

Positioned between a service node and the users, the OLT 100 is a subsystem that receives broadcast and communication signals transmitted from broadcast and communication providers, combines them to an optical signal after electro-optical conversion and then transmits the optical signal. The ONTs 200-1 to 200-N are user-side devices for transferring information received from the OLT 100 to the users.

Specifically, the OLT 100 optically converts a broadcast signal received from a broadcast network through O/E and E/O converters 115, 116, optically amplifies the converted signal through an EDFA (Erbium Doped Fiber Amplifier) 117 and transmits the amplified signal. The OLT 100 also receives communication data from an IP (Internet Protocol) network through an IP router 111, processes the data into an optical signal through an E-PON OLT function processor 112, and then transmits the processed data through a transmitter 113. In addition, the OLT 100 receives data from the ONTs 200-1 to 200-N, and transmits it to the IP network through the IP router 111.

The ONTs 200-1 to 200-N receive broadcast signals through broadcast receivers 119-1 to 119-N, and transfer them to users through broadcast STBs (Set Top Box) 122-1 to 122-N. The ONTs 200-1 to 200-N likewise receive communication data through receivers 120-1 to 120-N, and transfer it to users through E-PON ONT function processors 123-1 to 123-N. From the upstream perspective, the ONTs 200-1 to 200-N receive communication data from users through the E-PON ONT function processors 123-1 to 123-N, and transmit it to the OLT 100 through burst-mode transmitters 121-1 to 121-N.

Disadvantageously, transfer of analog broadcast signals from the OLT 100 to the ONTs 200-1 to 200-N requires the (EDFA) 117 which is relatively high-priced. This holds true even if exclusively digital broadcast signals are accommodated in the case where there are a large number of digital broadcast channels. Further, since all broadcast channels are transmitted to each of the ONTs 200-1 to 200-N, it is required for the ONTs 200-1 to 200-N to include a high-specification, high-cost optical receiver, which has high reception sensitivity and excellent noise characteristics, in order to receive the transmitted broadcast signals.

It is expected that future users will demand not only digital broadcast services but also high-quality, real-time digital image services. However, it is difficult for the conventional Ethernet-PON to accommodate the high-quality, real-time digital image signals. The conventional Ethernet-PON also must include the CAS as a separate, high-cost system for security and authentication for each subscriber.

To overcome these problems, a different network system has been suggested in which only broadcast/image signals selected by users are provided from the OLT 100 in the Ethernet-PON to the users, instead of equally transmitting all channels to each user. This system also has a problem, however, in that it requires a separate security device since the broadcast/image signals selected by users are equally transmitted to every user.

### SUMMARY OF THE INVENTION

The present invention has been made in view of the above problems in the prior art, and it is an object of the present invention to provide an Ethernet passive optical network (PON) capable of accommodating real-time broadcast/image signals, of providing security for broadcast/image signals, and of authenticating users without utilizing a CAS.

It is another object of the present invention to assign a unique scrambling and descrambling polynomial to a user in order to overcome broadcast/image security problems in an Ethernet-PON in which all broadcast/image channels selected by users are equally transmitted to every user.

In accordance with the present invention, the above and other objects can be accomplished by the provision of an Ethernet-PON (Passive Optical Network) accommodating real-time broadcast and/or image signals and configured for providing security for the accommodated signals. The network includes an OLT (Optical Line Terminal) for switching between digital broadcast and/or digital image data received from an external broadcast provider, according to respective broadcast and/or image selection information of users received from the users. The network scrambles the switched digital data on a user-by-user basis, multiplexing the scrambled digital data into a single signal. Both the multiplexed signal and the communication data received through an IP (Internet Protocol) network are electro-optically converted, coupling and transmitted. Each of a plurality of ONTs (Optical Network Terminals) receives from the OLT an optical signal, separates the received optical signal into the converted digital and communication data, photoelectrically converts the separated data, selects broadcast and/or image data from the photoelectrically converted digital data according to the corresponding broadcast and/or image selection information, and descrambles the selected broadcast and/or image data on a user-by-user basis to produce an output signal. The separated, converted communication data and the output signal are outputted to a corresponding user. Each ONT further receives an upstream communication signal and the broadcast and/or image selection information from the user, and outputs to the OLT the upstream communication signal and the broadcast and/or image selection information. The network further has an optical splitter for splitting a signal from the OLT among the ONTs, coupling signals from the plural ONTs to create a combined signal, and transmitting the combined signal to the OLT.

### BRIEF DESCRIPTION OF THE DRAWINGS

The above features and other advantages of the present invention will be more clearly understood from the following detailed description taken in conjunction with the accompanying drawings, in which:

FIG. 1 shows the configuration of a general Ethernet-PON for integrating broadcast and communication;

FIGS. 2A and 2B show the configuration of an Ethernet-PON accommodating real-time broadcast/image signals and being capable of providing security for broadcast/image signals, according to an embodiment of the present invention; and

FIG. 3 shows the configuration of an example of a scrambler used in an Ethernet-PON accommodating real-time broadcast/image signals and being capable of providing security for broadcast/image signals, according to the present invention.

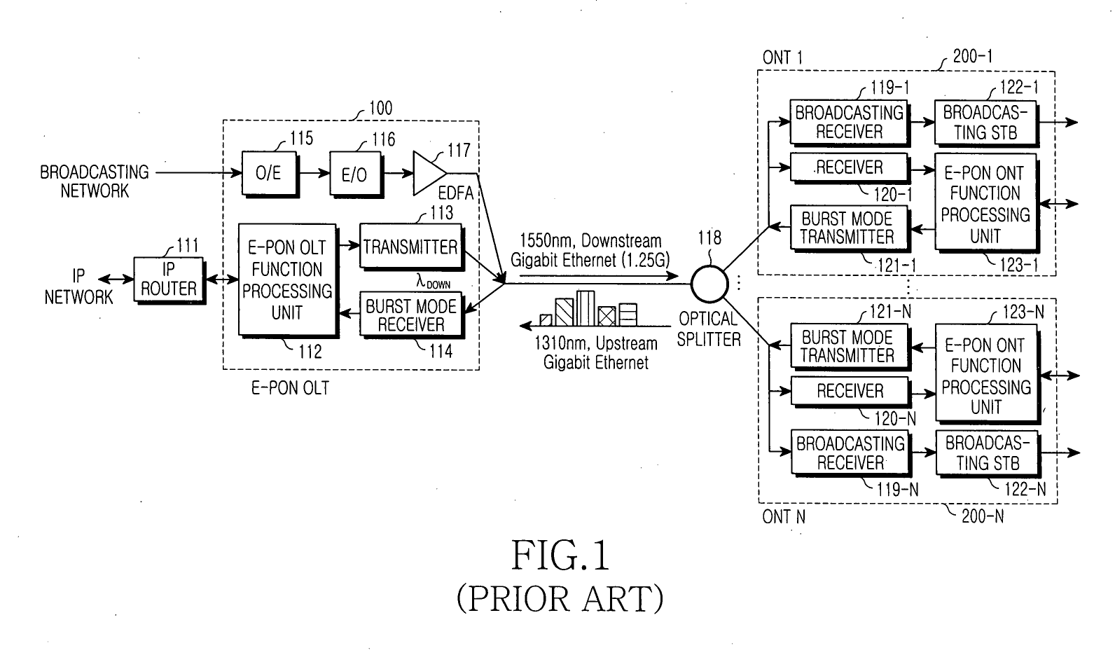

### DETAILED DESCRIPTION OF THE PREFERRED EMBODIMENTS

Preferred embodiments of the present invention are described below in detail with reference to the annexed drawings. Detailed description of known functions and configurations incorporated herein is omitted for clarity of presentation.

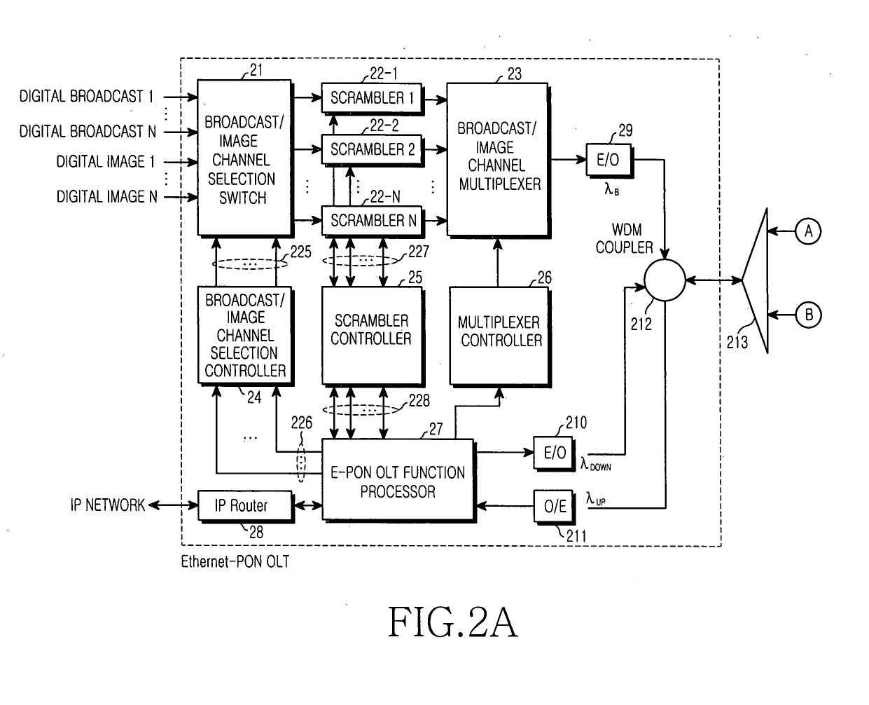

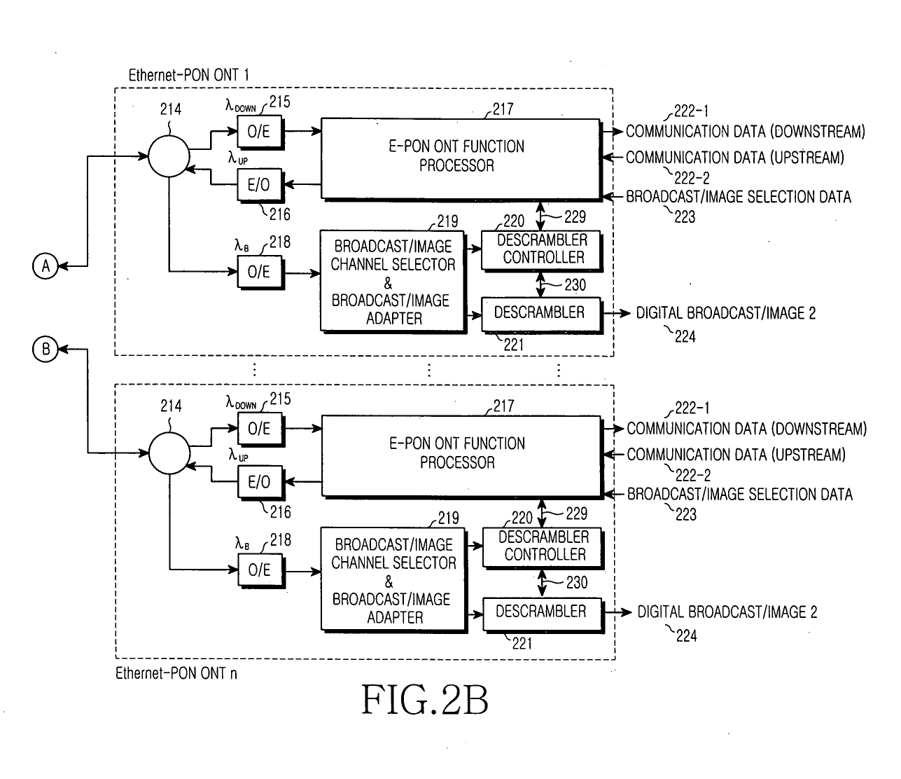

FIGS. 2A and 2B show, by way of illustrative and non-limitative example, an Ethernet passive optical network (PON) in accordance with the present invention, which accommodates real-time broadcast/image signals and is capable of providing security for broadcast/image signals. The PON includes a single OLT, an optical splitter 213, and n ONTs. The n ONTs are respectively assigned to n users or “subscribers.” The terms “subscriber” and “ONT” may also be used interchangeably in the description of the present invention.

Referring to FIG. 2A, the OLT includes a broadcast/image channel selection switch 21, scramblers 22-1, 22-2, . . . , 22-N corresponding respectively to the subscribers, a broadcast/image channel multiplexer 23, a broadcast/image channel controller 24, a scrambler controller 25, a multiplexer controller 26, an Ethernet-PON OLT function processor 27, an IP router 28, an optical transmitter 29, an optical transmitter 210, an optical receiver 211, and a WDM coupler 212. The broadcast/image channel selection switch 21 functions to perform a switching operation on MPEG (Motion Picture Experts Group) broadcast/image data. The broadcast/image channel selection controller 24 controls the channel selection switch 21 to perform a switching operation on MPEG broadcast/image data corresponding to each subscriber based on broadcast/image channel selection information from each subscriber. The scramblers 22-1, 22-2, . . . , 22-n, corresponding respectively to the subscribers, scramble selected broadcast/image signals based on unique polynomials assigned respectively to the subscribers. The broadcast/image channel multiplexer 23 multiplexes the scrambled broadcast/image signals, corresponding respectively to the subscribers, into a single broadcast/image signal. The optical transmitter 29 optically modulates the multiplexed broadcast/image signal. The IP router 28 routes communication data to an upper level IP network or to the Ethernet-PON OLT function processor 27. The Ethernet-PON OLT function processor 27 performs Ethernet-PON OLT functions. The scrambler controller 25 assigns the unique polynomials, corresponding respectively to the subscribers, to the broadcast/image channels selected by the subscribers, respectively, and controls them. The multiplexer controller 26 controls the broadcast/image channel multiplexer 23. The optical transmitter 210 transmits an Ethernet communication optical signal to the ONTs. The optical receiver 211 receives an Ethernet communication optical signal from the ONTs through the WDM coupler 212. The WDM coupler 212 couples an Ethernet communication optical signal and a broadcast/image optical signal, and transmits the coupled signal to the ONTs, and receives an Ethernet communication optical signal from the ONTs.

As shown in FIG. 2B, each of the ONTs includes a WDM coupler 214, optical receiver and transmitter 215 and 216, an Ethernet-PON ONT function processor 217, an optical receiver 218, a broadcast/image channel selector & broadcast/image adapter 219, a descrambler controller 220, and a descrambler 221. The WDM coupler 214 receives an optical signal from the OLT and separates it into an Ethernet communication optical signal and a broadcast/image optical signal. The optical receiver 215 receives and photoelectrically converts the Ethernet communication optical signal transmitted from the OLT. The optical transmitter 216 electro-optically converts Ethernet communication data in order to transmit it to the OLT. The Ethernet-PON ONT function processor 217 performs ONT functions. The optical receiver 218 receives and photoelectrically converts the broadcast/image optical signal. The broadcast/image channel selector & broadcast/image adapter 219 selects a broadcast/image channel, selected by a corresponding subscriber, from the broadcast/image data converted into an electrical signal by the optical receiver 218, and recovers an associated original broadcast/image channel. The descrambler 221 descrambles the selected broadcast/image channel based on a polynomial assigned to the subscriber. The descrambler controller 220 controls the descrambler 221.

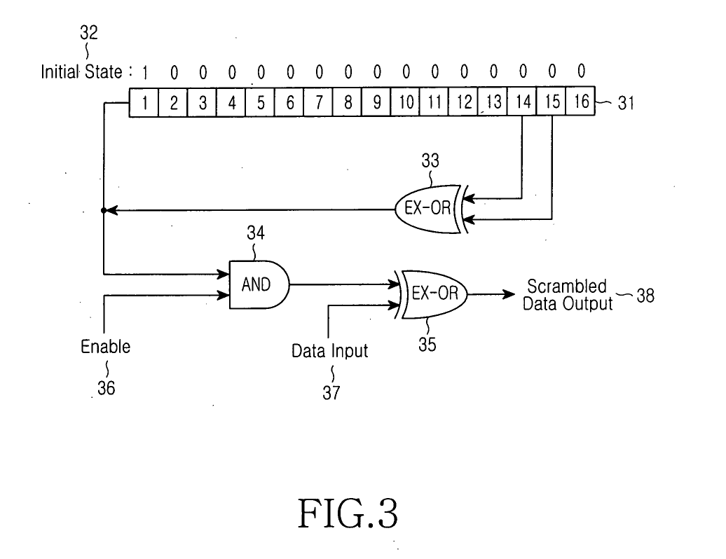

As shown in FIG. 3, the exemplary scrambler used in the Ethernet-PON, which accommodates real-time broadcast/image signals and is capable of providing security for broadcast/image signals, includes a shift register 31, first and second exclusive-OR gates 33, 35, and an AND gate 34. The scrambler includes 16 bits, but can be extended by increasing the number of elements of the shift registers 31. A polynomial in an n-bit scrambler can be expressed by the following equation:
p(x)=cₙXⁿ+cₙ₋₁Xⁿ⁻¹+ . . . +c₂X²+c₁X¹+1,
where cᵢ is a constant of ‘0’ or ‘1’, and xⁱ denotes the value of an i-th element of the shift register 31.

The constant c is set to ‘1’ for elements of the shift register 31 connected to the first exclusive-OR gate 33, and to ‘0’ for the other elements of the shift register. Here, the scrambling values may be changed by adjusting the initial state of the shift register 31 and the polynomial p(x), and the scrambling polynomial may be adjusted by external setting.

The polynomial shown is p(x)=x¹⁵+x¹⁴+1, corresponding to an initial state 32 or bit values ‘0000000010101001’. When the scrambler starts operation, the initial values stored in the shift register 31 begin to shift right. The 14th and 15th outputs of the shift register 31 are inputted to the first exclusive-OR gate 33, whose output serves as input to both the first element of the shift register 31 and to the AND gate 34. The scrambler can be activated or stopped by adjusting an enable signal 36 to ‘1’ or ‘0’, respectively. The output of the AND gate 34 has a random data form, and the output of the AND gate 34 and a data input signal 37 serve as input to the exclusive OR gate 35, from which scrambled data 38 is outputted. The input signal 37 is randomized in this manner, and is recovered at a descrambler 221 in an ONT utilizing the same polynomial as the scrambler.

In downstream operation, an MPEG digital broadcast/image signal is inputted to the broadcast/image channel selection switch 21 that switches for output to scramblers 22-1 to 22-N the digital broadcast channel desired by the respective subscriber. Each subscriber assigns a broadcast/image channel he or she desires to watch through a remote controller. The latter transmits the broadcast/image selection data 223 upstream for output by the E-PON OLT function processor 27 as signaling 226 to the broadcast/image channel selection controller 24. The controller 24 transfers the broadcast/image channel selection information 223, 226 as control signals 225 to the broadcast/image channel selection switch 21.

When subscribers of some ONTs select broadcast/image channels, respectively, the E-PON OLT function processor 27 informs the scrambler controller 25 that the ONTs have requested the broadcast/image channels. The controller 25 sets specific polynomials p(x) and initial states corresponding respectively to the subscribers, and transfers them to the corresponding scramblers 22-1, 22-2, . . . , 22-n to which data of the broadcast/image channels selected by the subscribers is inputted. Information of the set specific polynomials p(x) and initial states corresponding respectively to the subscribers is transferred to the E-PON OLT function processor 27, converted to Ethernet communication data and transferred to the respective subscribers to be used as descrambling information.

In the above method, a specific polynomial p(x) and initial state for each subscriber for scrambling is determined each time a subscriber selects a broadcast/image channel. A different method is also possible, in which a specific polynomial p(x) and initial state for each subscriber, previously fixed, is assigned to each subscriber, although detailed description of the associated embodiment is omitted herein.

As an example of the former method, when the first, second and sixteenth ONTs select broadcast/image channels, the E-PON OLT function processor 27 transfers the selection information 228 to the scrambler controller 25. The scrambler controller 25 produces specific polynomials p(x) and initial states, respectively, for the ONTs in order to scramble the respective broadcast/image channels selected by the ONTs. Assuming that the scramblers 22-1 to 22-N are ordered according to the ONTs, the scrambler controller 25 produces a polynomial p1(x) and an initial state I1 for a channel selected by the first ONT, p2(x) and I2 for a channel selected by the second ONT, and p16(x) and I16 for a channel selected by the sixteenth ONT.

The produced specific polynomials p(x) and initial states 227 are transferred to the scramblers 22-1, 22-2 and 22-16, respectively, which scramble the respective broadcast/image channels for the first, second and sixteenth ONTs outputted from the broadcast/image channel selection switch 21. The same polynomials p(x) and initial states 227 as transferred to the scramblers 22-1, 22-2 and 22-16 are also transferred as signals 228 to the E-PON OLT function processor 27, so that they are converted to Ethernet communication data and then transmitted to each ONT. Upon receipt of this information, an ONT extracts information of a polynomial p(x) and an initial state assigned to itself, and uses it to descramble the corresponding broadcast/image channel.

Alternatively, polynomials p(x) and initial states may be fixed for respective ones of the scramblers 22-1, 22-2, . . . , 22-n, as assigned at the initial setting of the Ethernet-PON. Accordingly, a fixed polynomial pi(x) and initial state Ii is assigned to a scrambler i, serving to scramble a broadcast/image channel selected by an i-th ONT, at the initial operation of the Ethernet-PON, and the information thereof is transferred to the i-th ONT to perform the scrambling and descrambling operations.

The broadcast/image data outputted via the scrambling process, according to any of the above-described embodiments, is inputted to the broadcast/image channel multiplexer 23, at which it is multiplexed into a single signal. The multiplexed signal is electro-optically converted at the optical transmitter 29 to a signal of wavelength λ_{B}. The converted signal is combined with an Ethernet communication optical signal at the WDM coupler 212, and the combined signal is transmitted to the ONTs. The multiplexer controller 26 controls the broadcast/image channel multiplexer 23 according to the kind of multiplexing method utilized. In a time division multiplexing scheme, for instance, broadcast/image data is divided and inputted to time-slots. A frequency division multiplexing scheme subjects broadcast/image data to frequency division multiplexing after QAM (Quadrature Amplitude Modulation).

Ethernet communication data received from an upper level IP network is subjected to E-PON OLT function processing at the E-PON OLT function processor 27 after passing through the IP router 28. The data is then optically modulated at the optical transmitter 210 to a wavelength λ_{DOWN}, which is combined with the broadcast/image optical signal of wavelength λ_{B} at the WDM coupler 212 to be transmitted to the ONTs.

After being combined at the WDM coupler 212, the optical signal of wavelength λ_{DOWN} and the broadcast/image optical signal of wavelength λ_{B} are distributed to each ONT through the optical splitter 213. The combined signal is then separated into a communication optical signal of wavelength λ_{DOWN} and a broadcast/image optical signal of wavelength λ_{B} through the WDM coupler 214 in the ONT.

The separated communication optical signal of wavelength λ_{DOWN} is photoelectrically converted at the optical receiver 215, which is then transmitted as downward communication data 222-1 to a terminal device such as a computer through the E-PON ONT function processor 217. The converted signal of wavelength λ_{DOWN} includes the information of specific polynomials p(x) and initial states assigned respectively to the ONTs. The i-th ONT extracts only the information of a specific polynomial p(x) and initial state assigned to itself, and transmits a signal 229 conveying this information to the descrambler controller 220.

On the other hand, the broadcast/image optical signal of wavelength λ_{B} is inputted to the broadcast/image channel selector & broadcast/image adapter 219 after being photoelectrically converted at the optical receiver 218. The unit 219, in performing broadcast/image adaptation, extracts a broadcast/image channel selected by itself (i.e., by the corresponding subscriber) from the inputted signal, which corresponds to the broadcast/image channel selection operation of the unit 219, and recovers the extracted signal in its data format before having been multiplexed. A broadcast/image signal outputted from the unit 219 must be descrambled since it has been scrambled. This descrambling operation requires the information of a specific polynomial p(x) and initial state used for the scrambling. Since this information has been transmitted to the descrambler controller 220 after being extracted at the E-PON ONT function processor 217, it is transmitted as signal 230 from the descrambler controller 220 to the descrambler 221, so that the scrambled broadcast/image channel 224 is recovered.

If a different broadcast/image channel selected by a different subscriber is selected at the channel selector & broadcast/image adapter 219, the subscriber cannot watch the different channel. This is because the different channel has been scrambled with a respectively different polynomial and initial state, causing incorrect data to be produced by the descrambling at the descrambler 221. Unbeatable broadcast/image channel security can therefore be provided to each subscriber.

In upstream operation, each subscriber produces IP communication data 222-2 through a computer, etc., and produces broadcast/image channel selection data 223 for watching a digital broadcast/image channel.

After overcoming problems such as data collision through the E-PON ONT function processor 217, the produced data is electro-optically converted into an optical signal having a wavelength λ_{UP} at the optical transmitter 216. The converted optical signal is transmitted to the OLT via the WDM coupler 214 and the optical splitter 213.

After being separated by the WDM coupler 212 in the OLT, the upstream signal is received by the optical receiver 211. Of the data received by the E-PON OLT function processor 27, broadcast/image channel selection information 226 is transferred to the broadcast/image channel selection controller 24, and IP communication data is transferred to the upper level IP network or other OLTs through the IP router 28.

As apparent from the above description, the present invention has an advantage in that it allows user authentication without a CAS in an Ethernet-PON accommodating real-time broadcast/image signals.

In addition, by assigning a unique scrambling and descrambling polynomial to a user, the present invention overcomes security problems of broadcast/image data in an Ethernet-PON in which all broadcast/image channels selected by users are equally transmitted to every user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An Ethernet-PON (Passive Optical Network) accommodating real-time broadcast and/or image signals and configured for providing security for the accommodated signals, comprising:
an OLT (Optical Line Terminal) for switching between a plurality of digital broadcast and/or digital image data received from an external broadcast provider, according to respective broadcast and/or image selection information of users received from the users, scrambling the switched digital data on a user-by-user basis, multiplexing the scrambled digital data into a single signal, electro-optically converting the multiplexed signal, electro-optically converting communication data received through an IP (Internet Protocol) network, coupling the converted digital and communication data, and transmitting the coupled signal;
a plurality of ONTs (Optical Network Terminals), each ONT receiving from the OLT an optical signal, separating the received optical signal into said converted digital and communication data, photoelectrically converting the separated data, selecting broadcast and/or image data from the photoelectrically converted digital data according to the corresponding broadcast and/or image selection information, descrambling the selected broadcast and/or image data on a user-by-user basis to produce an output signal, outputting the separated, converted communication data and said output signal to a corresponding user, receiving an upstream communication signal and said broadcast and/or image selection information from the user, and outputting to the OLT said upstream communication signal and said broadcast and/or image selection information; and
an optical splitter for splitting a signal from the OLT among the plural ONTs, coupling signals from the plural ONTs to create a combined signal, and transmitting to the OLT said combined signal.

2. The Ethernet-PON according to claim 1, wherein the OLT receives digital broadcast data and digital image data, and wherein each of the plurality of ONTs includes:
a wavelength division multiplexing (WDM) coupler for separating an optical signal received from the OLT into a communication signal of wavelength λ_{DOWN} and a broadcast/image signal of wavelength λ_{B};
an optical receiver for receiving the separated communication signal of wavelength λ_{DOWN}, and converting the received signal of wavelength λ_{DOWN} into an electrical signal;
another optical receiver for receiving the separated broadcast/image signal of λ_{B}, and converting it into an electrical signal;
an Ethernet-PON ONT function processor for performing ONT functions;
another optical transmitter for receiving broadcast/image selection information and a communication signal to be transmitted to the OLT from a corresponding user through the Ethernet-PON ONT function processor, and transmitting said broadcast/image information and a communication signal as an optical signal λ_{UP};
a broadcast/image channel selector & broadcast/image adapter for selecting a broadcast/image signal according to the broadcast/image selection information selected by the user, and recovering an associated original broadcast/image channel;
a descrambler for descrambling the broadcast/image signal recovered through the channel selector & broadcast/image adapter, and transferring the descrambled, recovered signal to the user; and
a descrambler controller for controlling the descrambler to perform the descrambling operation by transferring the scrambling information corresponding to the ONT from the Ethernet-PON ONT function processor to the descrambler.

3. The Ethernet-PON according to claim 2, wherein specific functions and initial states are assigned to the ONTs, respectively, to allow the respective scramblers and descramblers to perform the scrambling and descrambling operations.

4. The Ethernet-PON according to claim 3, wherein the scrambler for performing the scrambling operation based on the specific function and initial state includes:
a shift register for storing the initial state and performing a shift operation by the subsequent logical operations;
a first exclusive-OR gate for performing an exclusive-OR operation between element values of the shift register, and outputting the resulting value to an input of the shift register;
an AND gate for performing an AND operation between an output of the first exclusive-OR gate and an external enable signal; and
a second exclusive-OR gate for performing an exclusive-OR operation between input data and an output of the AND gate, and outputting the resulting value.

5. The Ethernet-PON according to claim 4, wherein the specific function is expressed by the following equation:
p(x)=cₙXⁿ+cₙ₋₁Xⁿ⁻¹+ . . . +c₂X²+c₁X¹+1,
where cᵢ is a constant of ‘0’ or ‘1’, xⁱ denotes the value of an i-th element of the shift register, and the constant c is set to ‘1’ for elements of the shift register connected to the first exclusive-OR gate, and to ‘0’ for the other elements of the shift register.

6. The Ethernet-PON according to claim 1, wherein the OLT includes:
a broadcast/image channel selection switch for receiving external MPEG (Motion Picture Experts Group) broadcast and image data, and switching and outputting said broadcast and image data on a user-by-user basis;
a plurality of scramblers for scrambling broadcast/image channels outputted from the broadcast/image channel selection switch on a user-by-user basis;
a multiplexer for receiving the scrambled broadcast/image signals from the plural scramblers, and combining them into a single broadcast/image signal;
a first optical transmitter for optically modulating said single broadcast/image signal;
an Ethernet-PON OLT function processor for performing Ethernet-PON OLT functions;
a scrambler controller for controlling the plural scramblers according to respective broadcast/image selection information of the users from the Ethernet-PON OLT function processor;
an IP router for routing communication data to an upper level IP network or to the Ethernet-PON OLT function processor;
a second optical transmitter for optically modulating communication data to be transmitted to the plural ONTs;
a first optical receiver for receiving an optical signal from the plural ONTs, and converting into an electrical signal, and then transferring to the Ethernet-PON OLT function processor after its conversion, said optical signal from the plural ONTs that has been received;
a broadcast/image channel selection controller for receiving the broadcast/image selection information from the plural ONTs through the Ethernet-PON OLT function processor, and outputting a control signal to the broadcast/image channel selection switch so as to allow the switch to select broadcast/image channels corresponding respectively to the plural ONTs; and
a first wavelength division multiplexing (WDM) coupler for coupling an optically modulated communication signal of wavelength λ_{DOWN} and an optically modulated broadcast/image signal of wavelength λ_{B}, and outputting the resulting signal.

7. The Ethernet-PON according to claim 6, wherein each of the plurality of ONTs includes:
a second WDM coupler for separating an optical signal received from the OLT into a communication signal of wavelength λ_{DOWN} and a broadcast/image signal of wavelength λ_{B};
a second optical receiver for receiving the separated communication signal of wavelength λ_{DOWN}, and converting the signal of wavelength λ_{DOWN} into an electrical signal;
a third optical receiver for receiving the separated broadcast/image signal of wavelength λ_{B}, and converting into an electrical signal the received signal of wavelength λ_{B};
an Ethernet-PON ONT function processor for performing ONT functions;
a third optical transmitter for receiving broadcast/image selection information and a communication signal to be transmitted to the OLT from a corresponding user through the Ethernet-PON ONT function processor, and transmitting said broadcast/image selection information and a communication signal as an optical signal λ_{UP};
a broadcast/image channel selector & broadcast/image adapter for selecting a broadcast/image signal according to the broadcast/image selection information selected by the user, and recovering an associated original broadcast/image channel;
a descrambler for descrambling the broadcast/image signal recovered through the channel selector & broadcast/image adapter, and transferring the descrambled, recovered signal to the user; and
a descrambler controller for controlling the descrambler to perform the descrambling operation by transferring the scrambling information corresponding to the ONT from the Ethernet-PON ONT function processor to the descrambler.

8. The Ethernet-PON according to claim 7, wherein specific functions and initial states are assigned to the ONTs, respectively, to allow the respective scramblers and descramblers to perform the scrambling and descrambling operations.

9. The Ethernet-PON according to claim 8, wherein the scrambler for performing the scrambling operation based on the specific function and initial state includes:
a shift register for storing the initial state and performing a shift operation by the subsequent logical operations;
a first exclusive-OR gate for performing an exclusive-OR operation between element values of the shift register, and outputting the resulting value to an input of the shift register;
an AND gate for performing an AND operation between an output of the first exclusive-OR gate and an external enable signal; and
a second exclusive-OR gate for performing an exclusive-OR operation between input data and an output of the AND gate, and outputting the resulting value.

10. The Ethernet-PON according to claim 9, wherein the specific function is expressed by the following equation:
p(x)=cₙXⁿ+cₙ₋₁Xⁿ⁻¹+ . . . +c₂X²+c₁X¹+1,
where cᵢ is a constant of ‘0’ or ‘1’, xⁱ denotes the value of an i-th element of the shift register, and the constant c is set to ‘1’ for elements of the shift register connected to the first exclusive-OR gate, and to ‘0’ for the other elements of the shift register.

11. The Ethernet-PON according to claim 6, wherein the OLT further includes a multiplexer controller for controlling said multiplexer for receiving the scrambled broadcast/image signals to combine the scrambled broadcast/image signals into the single signal according to a time division multiplexing scheme.

12. The Ethernet-PON according to claim 11, wherein each of the plurality of ONTs includes:
a second WDM coupler for separating an optical signal received from the OLT into a communication signal of wavelength λ_{DOWN} and a broadcast/image signal of wavelength λ_{B};
a second optical receiver for receiving the separated communication signal of wavelength λ_{DOWN}, and converting the signal of wavelength λ_{DOWN} into an electrical signal;
a third optical receiver for receiving the separated broadcast/image signal of wavelength λ_{B}, and converting into an electrical signal the received signal of wavelength λ_{B};
an Ethernet-PON ONT function processor for performing ONT functions;
a third optical transmitter for receiving broadcast/image selection information and a communication signal to be transmitted to the OLT from a corresponding user through the Ethernet-PON ONT function processor, and transmitting said broadcast/image selection information and a communication signal as an optical signal λ_{UP};
a broadcast/image channel selector & broadcast/image adapter for selecting a broadcast/image signal according to the broadcast/image selection information selected by the user, and recovering an associated original broadcast/image channel;
a descrambler for descrambling the broadcast/image signal recovered through the channel selector & broadcast/image adapter, and transferring the descrambled, recovered signal to the user; and
a descrambler controller for controlling the descrambler to perform the descrambling operation by transferring the scrambling information corresponding to the ONT from the Ethernet-PON ONT function processor to the descrambler.

13. The Ethernet-PON according to claim 12, wherein specific functions and initial states are assigned to the ONTs, respectively, to allow the respective scramblers and descramblers to perform the scrambling and descrambling operations.

14. The Ethernet-PON according to claim 13, wherein the scrambler for performing the scrambling operation based on the specific function and initial state includes:
a shift register for storing the initial state and performing a shift operation by the subsequent logical operations;
a first exclusive-OR gate for performing an exclusive-OR operation between element values of the shift register, and outputting the resulting value to an input of the shift register;
an AND gate for performing an AND operation between an output of the first exclusive-OR gate and an external enable signal; and
a second exclusive-OR gate for performing an exclusive-OR operation between input data and an output of the AND gate, and outputting the resulting value.

15. The Ethernet-PON according to claim 6, wherein the OLT further includes a multiplexer controller for controlling said multiplexer for receiving the scrambled broadcast/image signals to combine the scrambled broadcast/image signals into the single signal according to a frequency division multiplexing scheme.

16. The Ethernet-PON according to claim 15, wherein the specific function is expressed by the following equation:
p(x)=cₙXⁿ+cₙ₋₁Xⁿ⁻¹+ . . . +c₂X²+c₁X¹+1,
where cᵢ is a constant of ‘0’ or ‘1’, xⁱ denotes the value of an i-th element of the shift register, and the constant c is set to ‘1’ for elements of the shift register connected to the first exclusive-OR gate, and to ‘0’ for the other elements of the shift register.

17. The Ethernet-PON according to claim 16, wherein each of the plurality of ONTs includes:
a second WDM coupler for separating an optical signal received from the OLT into a communication signal of wavelength λ_{DOWN} and a broadcast/image signal of wavelength λ_{B};
a second optical receiver for receiving the separated communication signal of wavelength λ_{DOWN}, and converting said signal of wavelength λ_{DOWN} into an electrical signal;
a third optical receiver for receiving the separated broadcast/image signal of λ_{B}, and converting into an electrical signal said broadcast/image signal of λ_{B};
an Ethernet-PON ONT function processor for performing ONT functions;
a third optical transmitter for receiving broadcast/image selection information and a communication signal to be transmitted to the OLT from a corresponding user through the Ethernet-PON ONT function processor, and transmitting as an optical signal λ_{UP} said broadcast/image selection information and a communication signal;
a broadcast/image channel selector & broadcast/image adapter for selecting a broadcast/image signal according to the broadcast/image selection information selected by the user, and recovering an associated original broadcast/image channel;
a descrambler for descrambling the broadcast/image signal recovered through the channel selector & broadcast/image adapter, and transferring the descrambled, recovered signal to the user; and
a descrambler controller for controlling the descrambler to perform the descrambling operation by transferring the scrambling information corresponding to the ONT from the Ethernet-PON ONT function processor to the descrambler.

18. The Ethernet-PON according to claim 17, wherein specific functions and initial states are assigned to the ONTs, respectively, to allow the respective scramblers and descramblers to perform the scrambling and descrambling operations.

19. The Ethernet-PON according to claim 18, wherein the scrambler for performing the scrambling operation based on the specific function and initial state includes:
a shift register for storing the initial state and performing a shift operation by the subsequent logical operations;
a first exclusive-OR gate for performing an exclusive-OR operation between element values of the shift register, and outputting the resulting value to an input of the shift register;
an AND gate for performing an AND operation between an output of the first exclusive-OR gate and an external enable signal; and
a second exclusive-OR gate for performing an exclusive-OR operation between input data and an output of the AND gate, and outputting the resulting value.

20. The Ethernet-PON according to claim 19, wherein the specific function is expressed by the following equation:
p(x)=cₙXⁿ+cₙ₋₁Xⁿ⁻¹+ . . . +c₂X¹+c₁X¹+1,
where cᵢ is a constant of ‘0’ or ‘1’, xⁱ denotes the value of an i-th element of the shift register, the constant c is set to ‘1’ for elements of the shift register connected to the first exclusive-OR gate, and to ‘0’ for the other elements of the shift register.
